(19) United States
(12) Patent Application Publication
(10) Pub. No.: US 2020/0064868 A1
(43) Pub. Date: Feb. 27, 2020

(54) UNMANNED AERIAL VEHICLE CONTROL

(71) Applicant: Amimon Ltd., Ra'anana (IL)

(72) Inventors: Chen Rosen, Mishmarot (IL); Itay Guy, Tel Aviv (IL); Konstantin Sharlaimov, Khabarovsk Krai (RU); Ram Ofir, Los Altos, CA (US)

(21) Appl. No.: 16/466,298

(22) PCT Filed: Nov. 30, 2017
(86) PCT No.: PCT/IB2017/057531

§ 371 Date: Jun. 4, 2019

Related U.S. Application Data
(60) Provisional application No. 62/430,367, filed on Dec. 6, 2016.

(51) Int. Cl. G05D 1/08; B64C 39/02

(52) U.S. Cl. CPC G05D 1/0858; B64C 2201/14; B64C 39/024

(57) ABSTRACT

A method of automatic roll control in a UAV includes adjusting UAV yaw, measuring UAV pitch, estimating UAV drag, and estimating UAV velocity from the drag. A system includes a processor and a memory including instructions to automatically control roll in the UAV responsive to UAV yaw adjustment. A method includes estimating velocity in the UAV.

### CROSS-REFERENCE TO RELATED APPLICATIONS

This application claims the benefit of priority from U.S. Provisional Patent Application No. 62/430,367, filed 6 Dec. 2016, which is hereby incorporated in its entirety by reference.

### FIELD OF THE INVENTION

The present invention relates to unmanned aerial vehicle (UAV) systems in general and more particularly to methods for controlling UAV flight.

### BACKGROUND OF THE INVENTION

Technological advancements have contributed to an increased popularity in the use UAVs. These UAVs, also commonly referred to as drones, may include fixed-wing aircrafts such as planes, and rotorcrafts such as helicopters and multi-rotor aircrafts. UAVs are generally piloted by a user (pilot) using one of two techniques; either by line-of-sight (LOS) or using first-person-view (FPV). Using LOS, the pilot actually views the UAV at all times and controls its flight using a remote control unit. Using FPV, a camera on board the UAV transmits using wireless communication a video image of the surroundings which is displayed to the pilot on a screen and/or on goggles (worn by the pilot) and the pilot controls its flight with the remote control unit.

One type of multi-rotor aircraft is a quadrotor which is powered by four rotors. An exemplary quadrotor 12 and remote control unit 14 are shown as part of an exemplary UAV system 10 in FIG. 1. Quadrotor 12 may have four rotors 24A, 24B, 24C and 24D, as shown in the figure. Remote control unit 14 may transmit commands to quadrotor 12 and may be used by the pilot to control the multi-rotor's flight.

The flight dynamics of quadrotor 12 may be described with reference to FIGS. 1 and 2A and 2B, and may include the following degrees of motion (relative to three dimensional space defined by the mutually orthogonal axes, x-axis, y-axis, and a z-axis):
a. forward (F) and backward (B) motion along the x-axis shown by double-headed arrow 20 in FIGS. 1 and 2A;
b. yaw motion rotating to the left (YL) and to the right (YR) relative to the z-axis and, as shown by double-headed curved arrow 22 in FIGS. 1 and 2B;
c. pitch at an angle relative to the x-axis, as shown by curved arrows 26A and 26B in FIG. 2A, PF (forward pitch) representing the direction of the pitch during forward movement, and PB (backward pitch) representing the direction of the pitch during backward movement;
d. roll at an angle relative to the y-axis, as shown by curved arrows 28A and 28B in FIG. 2B, RL (roll left) representing the direction of the roll towards the left of the z-axis and RR (roll right) representing the direction of the roll towards the right of the z-axis when quadrotor 12 is viewed from the back (in a direction towards forward motion).

Each rotor 24A-24D may produce a thrust and a torque about its center of rotation, and in addition a drag force opposing the direction of flight. If all rotors are spinning at the same angular velocity with opposing rotors spinning in the same direction and adjacent rotors in opposing directions (e.g. rotors 24A and 24D spin in a clockwise direction and 24B and 24C in a counterclockwise direction), the net torque resulting from all rotors and the angular acceleration (yaw) of quadrotor 12 is essentially zero. The altitude of quadrotor 12 may be adjusted or may hover at the same altitude by applying equal thrust to rotors 24A-24D. To induce yaw in quadrotor 12, a greater amount of thrust may be applied to the rotors rotating in one direction compared to the rotors rotating in the opposite direction (e.g. greater thrust in rotors 24A and 24D). To induce pitch or roll, greater thrust may be applied to only one of the two rotors rotating in the same direction (e.g. for PF greater thrust in rotors 24C and 24D compared to rotors 24A and 24B, for RL greater thrust in rotors 24B and 24D compared to 24A and 24C).

Remote control unit 14 may include two controls 16 and 18 which may be manipulated by the pilot and responsively may transmit commands to an on-board flight control system in quadrotor 12. The on-board flight control system may then control the thrust and torque of each of the rotors 24A-24D responsive to the received commands. Control 16 may be used to control yaw by moving the control in the direction towards YL or YR, and thrust by moving the control in the direction towards TH to increase thrust and toward TL to decrease thrust. Control 18 may be used to control pitch by moving the control in the direction towards PF or PB, and to control roll by moving the control in the direction towards RL or RR.

### SUMMARY OF THE PRESENT INVENTION

There is provided, in accordance with an embodiment of the present invention, a method of automatic roll control in a UAV, the method includes adjusting UAV yaw, measuring UAV pitch, estimating UAV drag, and estimating UAV velocity from the drag.

There is additionally provided, in accordance with an embodiment of the present invention, a method of estimating velocity in a UAV, the method includes measuring UAV pitch, estimating UAV drag, and estimating UAV velocity from the drag.

There is additionally provided, in accordance with an embodiment of the present invention, a system including a processor, and a memory including instructions to automatically control roll in a UAV responsive to UAV yaw adjustment, wherein the instructions include the steps of measuring a pitch of the UAV, calculating UAV drag based on the pitch, and determining UAV velocity based on the drag.

In some embodiments of the present invention, the velocity may be horizontal velocity.

In some embodiments of the present invention, the drag may be horizontal drag.

In some embodiments of the present invention, the method may include measuring vertical acceleration.

In some embodiments of the present invention, the method may include measuring horizontal acceleration.

In some embodiments of the present invention, the method may include determining a UAV vertical thrust.

In some embodiments of the present invention, the method may include determining a UAV horizontal thrust.

In some embodiments of the present invention, the method may include determining a UAV total thrust.

In some embodiments of the present invention, determining vertical thrust may include multiplying UAV mass times combined acceleration, wherein combined acceleration includes vertical acceleration and standard gravity g.

In some embodiments of the present invention, estimating UAV velocity from the drag includes a drag factor as a function of the measured pitch.

In some embodiments of the present invention, determining the UAV total thrust includes measuring an amount of current flowing into one or more UAV engines.

In some embodiments of the present invention, determining the UAV total thrust includes adjusting thrust in the UAV until the vertical acceleration is substantially equal to zero.

In some embodiments of the present invention, the method may include measuring an altitude of the UAV.

In some embodiments of the present invention, the method may include adjusting throttle to maintain a constant altitude during adjusting UAV yaw.

In some embodiments of the present invention, the instructions may include the step of measuring vertical acceleration.

In some embodiments of the present invention, the instructions may include the step of measuring horizontal acceleration.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary UAV system including a quadrotor and a remote control unit;

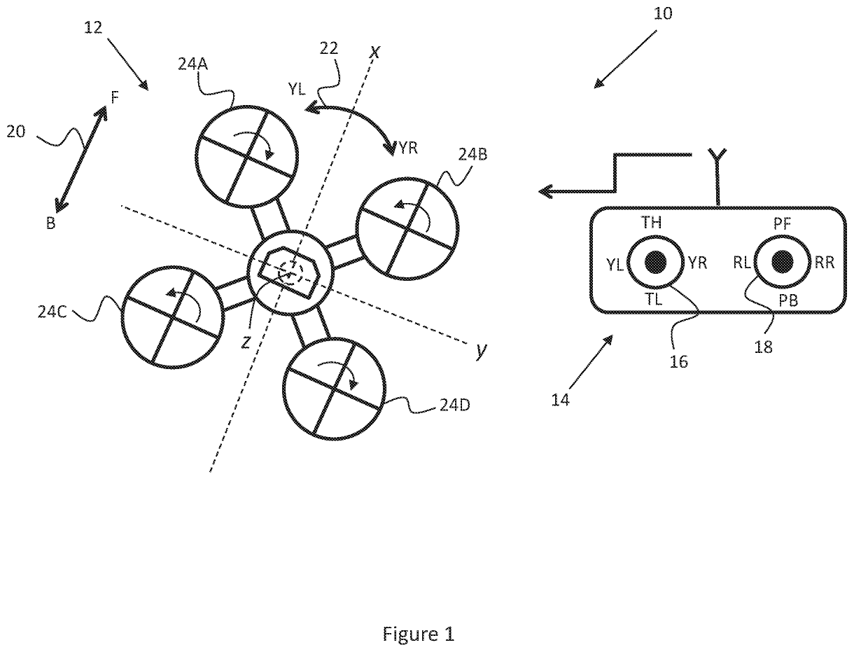

FIGS. 2A and 2B schematically illustrate the quadrotor including vectors associated with its flight dynamics and degrees of motion;

FIG. 3 is a flow diagram of an exemplary method for performing UAV single-control turns using the flight control function, according to an embodiment of the present invention;

FIG. 4 is a flow diagram of an exemplary method for automatically adjusting the angle of roll in the UAV using the flight control function including UAV speed estimation, according to an embodiment of the present invention;

FIG. 5 is a flow diagram of an exemplary method for determining horizontal drag in the UAV, according to an embodiment of the present invention; and

FIG. 6 schematically illustrates the thrust and drag forces acting on the quadrotor having a forward pitch angle θ.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Conducting a coordinated turn in a remote-controlled UAV during flight requires significant skills and co-ordination since the pilot has to control yaw, roll and pitch. The problem is exacerbated when the pilot is inexperienced and/or the speed of the UAV is relatively high. Applicants have realized that the problems associated with controlling UAV turning may be substantially ameliorated by including in the UAV system a flight control function which may allow the pilot to perform turns by only manipulating the yaw control. This flight control function may determine an angle of roll to compensate for the yaw during turning and may generate a roll command to automatically control roll in the UAV responsive to the pilot's manipulation of the yaw control.

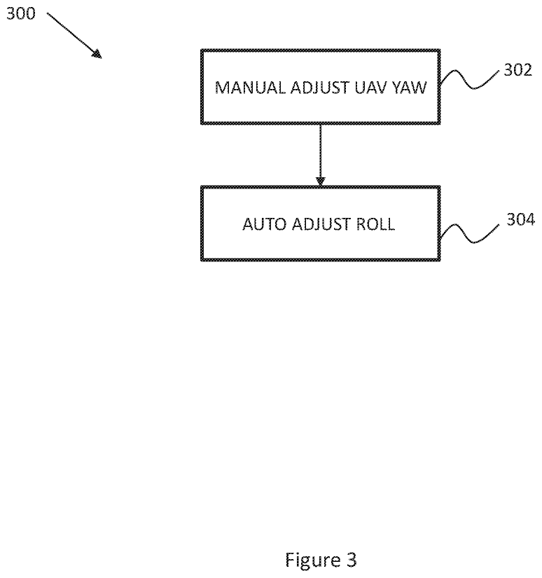

Reference is now made to FIG. 3 which is a flow diagram of an exemplary method 300 for performing UAV single-control turns using the flight control function, according to an embodiment of the present invention. The flight control function may be implemented in the UAV on-board flight control system as hardware, software, firmware, or any combination thereof. Additionally or alternatively, the flight control function may be implemented in the remote control unit as hardware, software, firmware, or any combination thereof

At 302, the pilot may manipulate the yaw control in the remote control unit to adjust the UAV yaw. The remote control unit may send a yaw control command to the UAV for processing by the UAV on-board flight control system.

At 304, responsive to receiving the yaw control command from the remote control unit, UAV roll may be automatically adjusted by the UAV on-board flight control system according to the roll angle generated by the flight control function. As previously mentioned, the flight control function may be implemented in the UAV on-board flight control system. Additionally or alternatively, the flight control function may be implemented in the remote control unit so that roll angle information (roll control command) may be automatically transmitted to the UAV for processing by the UAV on-board flight control system.

It may be appreciated that the flight control function may be used to generate an optimal automatic roll if the speed of the UAV is also considered in addition to the yaw. Means are known for measuring the speed of the UAV, nevertheless, Applicants have realized that there are numerous drawbacks associated with their use. For example, inertial navigation systems (INS) may be used with the UAV but these tend to be rather expensive and the accelerometers employed therein may require a high degree of accuracy as the speed is calculated as the integral of the acceleration. Another option may be the use of GPS although, as with the INS, GPS devices may be rather expensive and their performance may be limited when covered (e.g. under a roof). Still other options may include use of pilot tubes, optical flow sensors, and vision-based speed estimation means, but these again may be rather expensive and may contribute to a substantial increase in the cost of the UAV.

Applicants have further realized that the drawbacks associated with use of known means for determining the speed of the UAV may be overcome by having the on-board flight control system determine the UAV speed as a function of the UAV pitch and the UAV drag. Consequently, the flight control function may determine an optimal angle of roll to compensate for the yaw and speed during turning and may generate the roll command to automatically control roll in the UAV responsive to the pilot's manipulation of the yaw control.

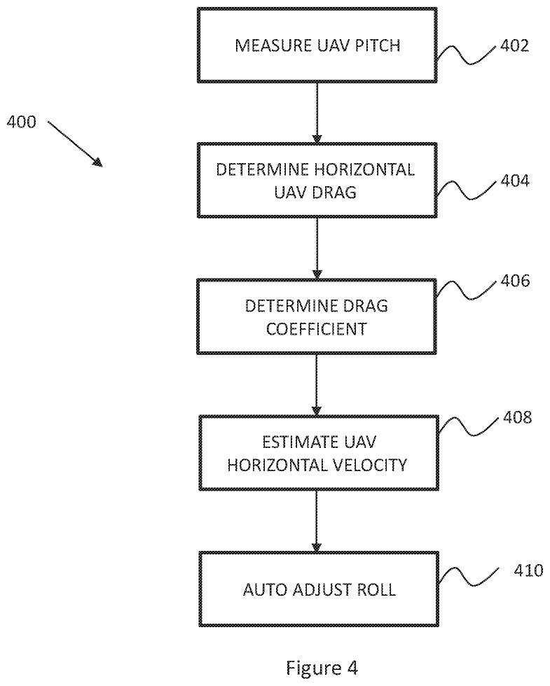

Reference is now made to FIG. 4 which is a flow diagram of an exemplary method 400 for automatically adjusting the angle of roll in the UAV using the flight control function including UAV speed estimation, according to an embodiment of the present invention. In some embodiments, the steps shown in method 400 may be used in step 302 of previously described method 300.

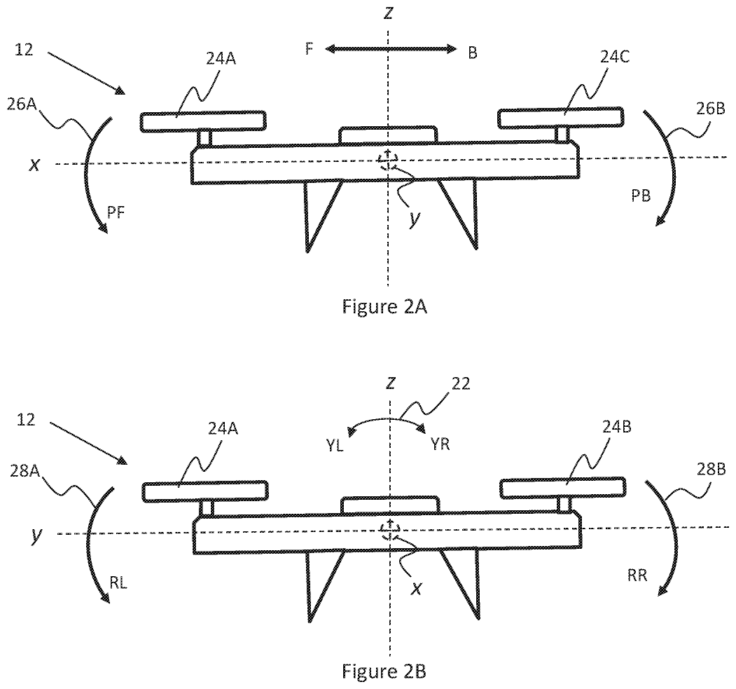

At 402, the pitch (pitch angle which may be designated θ) of the UAV may be measured. The pitch may be forward pitch (PF) or backward pitch (PB) depending on whether the UAV is flying forward or backward (see FIG. 2A). In some embodiments, pitch measurement may be performed by means of a gyroscope which is typically included in most (if not all) UAVs, although other known pitch measurement means and methods may be used, and which may include use of an inertial measurement unit (IMU).

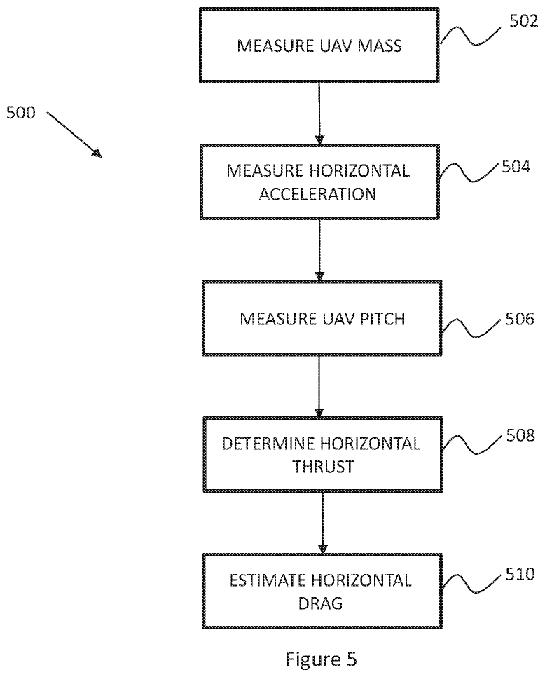

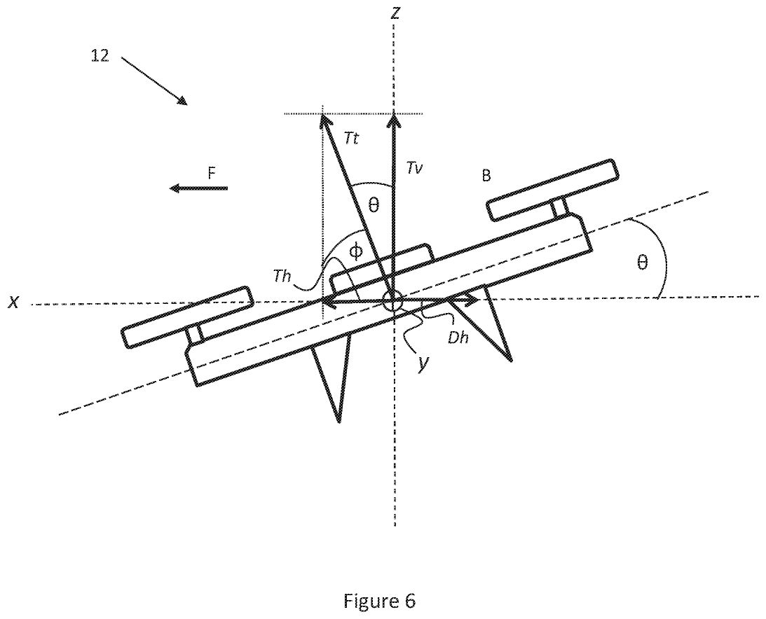

At 404, the horizontal drag of the UAV may be determined (along the x-axis, see FIG. 2A). In some embodiments, UAV drag may be determined as a function of the measured pitch from step 402, UAV thrust, and UAV acceleration, an exemplary method for determining UAV drag described further on below with reference to FIGS. 5 and 6. Nevertheless, it may be appreciated that method of determining UAV drag is not limited to the exemplary method shown therein, and that other methods may be used.

At 406, the drag coefficient a corresponding to the measured UAV pitch may be selected from a table which may be previously stored in memory in the on-board flight control system, or may be otherwise determined using known methods.

At 408, the horizontal velocity Vh of the UAV may be determined. The velocity may be determined using the following equation,

$${V}_{h} = \sqrt{\frac{1}{α ( θ )} {D}_{h}} ,$$

where α(θ) is the drag coefficient determined in step 406 at the measured pitch angle θ of step 402, and Dh is the horizontal drag determined in step 404.

At 410, responsive to receiving the yaw control command from the remote control unit and estimating of the UAV velocity, the roll may be automatically adjusted by the UAV on-board flight control system according to the roll angle generated by the flight control function.

Reference is now made to FIG. 5 which is a flow diagram of an exemplary method 500 for determining horizontal drag in the UAV, according to an embodiment of the present invention. In some embodiments, the steps shown in method 500 may be used in step 404 of previously described method 400. Method 500 may make reference to FIG. 6 which schematically illustrates the thrust and drag forces acting on the UAV, for example, quadrotor 12, having a forward pitch angle θ. It may be appreciated by the skilled person that method 500 may be practiced using more or less steps and/or a different sequence of steps.

At 502, the mass m of the UAV may be measured.

At 504, the UAV horizontal acceleration ah may be measured (along the x-axis). The measurement may be by an accelerometer in the UAV which is typically included in most (if not all) UAVs and used to measure horizontal acceleration along the x-axis. The UAV may additionally include an accelerometer to measure vertical acceleration av (along the z-axis) and typically included in UAVs. In some embodiments, the accelerometers may be included in an IMU in the UAV.

At 506, the pitch may be measured. This step may be similar to step 402 in method 400.

At 508, the UAV horizontal thrust Th may be determined. The horizontal thrust may be determined using any one of the following exemplary sub-methods, although the skilled person may appreciate that other sub-methods may be used to calculate.

Sub-Method A: Determine Vertical Thrust Tv

Vertical thrust Tv may first be calculated by Tv=m(av+g) where g=9.8 m/sec2.

Horizontal thrust Th may then be calculated by Th=Tv tan θ.

Sub-Method B: Determine Total Thrust Tt

Total thrust Tt may be first be determined by measuring the amount of current supplied to the rotors and converting the amount of current flow to total thrust. A predetermined conversion table relating Tt and current flow may be used for the conversion.

Horizontal thrust Th may then be calculated by Th=Tt cos ϕ where ϕ=90°−θ, or Th=Tt sin θ.

Sub-Method C: Determine Total Thrust Tt (Alternate)

Total thrust Tt may be determined by first determining vertical thrust Tv. This may be done by controlling UAV thrust until the vertical acceleration av=0 and measuring pitch angle θ. From sub-method A, Tv=mg; and total thrust may be calculated as Tt=Tv/cos θ. The vertical acceleration av may be substantially equal to zero (av=0) when the UAV is flying at a constant altitude or in a hovering state.

Horizontal thrust Th may then be calculated by Th=Tt cos ϕ where ϕ=90°−θ, or Th=Tt sin θ.

At 510, the UAV horizontal drag Dh may be determined. The horizontal drag may be determined using Dh=Th−m(ah).

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of automatic roll control in a UAV, the method comprising:
adjusting UAV yaw;
measuring UAV pitch;
estimating UAV drag; and
estimating UAV velocity from said drag.

2. A method according to claim 1 wherein said velocity is horizontal velocity.

3. A method according to claim 1 wherein said drag is horizontal drag.

4. A method according to claim 1 further comprising measuring vertical acceleration.

5. A method according to claim 1 further comprising measuring horizontal acceleration.

6. A method according to claim 1 further comprising determining a UAV vertical thrust.

7. A method according to claim 1 further comprising determining a UAV horizontal thrust.

8. A method according to claim 1 further comprising determining a UAV total thrust.

9. A method according to claim 6 wherein determining vertical thrust comprises multiplying UAV mass times combined acceleration, wherein combined acceleration comprises vertical acceleration and standard gravity g.

10. A method according to claim 1 wherein said estimating UAV velocity from said drag comprises a drag factor as a function of said measured pitch.

11. A method according to claim 8 wherein said determining the UAV total thrust comprises measuring an amount of current flowing into one or more UAV engines.

12. A method according to claim 8 wherein said determining the UAV total thrust comprises adjusting thrust in the UAV until the vertical acceleration is substantially equal to zero.

13. A method according to claim 1 further comprising measuring an altitude of the UAV.

14. A method according to claim 13 further comprising adjusting throttle to maintain a constant altitude during said adjusting UAV yaw.

15. A system comprising a processor and a memory including instructions to automatically control roll in a UAV responsive to UAV yaw adjustment, wherein said instructions comprise the steps of:
measuring a pitch of the UAV;
calculating UAV drag based on said pitch; and
determining UAV velocity based on the drag.

16. A system according to claim 15 wherein said velocity is horizontal velocity.

17. A system according to claim 15 wherein said drag is horizontal drag.

18. A system according to claim 15 wherein said instructions further comprise the step of measuring vertical acceleration.

19. A system according to claim 15 wherein said instructions further comprise the step of measuring horizontal acceleration.

20. A method of estimating velocity in a UAV, the method comprising:
measuring UAV pitch;
estimating UAV drag; and
estimating UAV velocity from said drag.
